(19) United States
(12) Patent Application Publication
(10) Pub. No.: US 2010/0038417 A1
(43) Pub. Date: Feb. 18, 2010

(54) SYSTEM AND METHOD FOR EXCHANGING INFORMATION

(76) Inventor: Avishay Blankitny, Shanghai (CN)

Correspondence Address: The Law Office of Michael E. Kondoudis, 888 16th Street, N.W., Suite 800, Washington, DC, 20006, US

(21) Appl. No.: 12/443,485

(22) PCT Filed: Jul. 31, 2007
(86) PCT No.: PCT/CN2007/070394

§ 371 Date: Mar. 30, 2009

(30) Foreign Application Priority Data
Sep. 28, 2006 (CN) 200510152775.6

(51) Int. Cl. G06Q 30/00; G06F 13/00

(52) U.S. Cl. 235/375

(57) ABSTRACT

A system for collecting (or exchanging) product information includes: a registering device (1), and a label reader (42). The registering device (1) is adapted for entering a visitor ID; the label reader (42) has a label reader ID, and includes a reading unit for reading label information from a label associated with a product, so as to acquire product information form related to the product; wherein the label reader ID corresponds to the visitor ID.

### CROSS REFERENCE TO RELATED APPLICATION

The application claims the priority of Chinese patent application No. 200610152775.6 submitted with the State Intellectual Propriety Office of P.R.C. on Sep. 28, 2006, entitled “System and Method for Collecting Product Information”, the content of which is incorporated herein by reference.

### FIELD OF THE INVENTION

The present invention relates to a system and a method for collecting and exchanging information, and in particular, to a system and a method for collecting the information of products that are presented and exhibited and for exchanging related information between the interested parties.

### BACKGROUND OF THE INVENTION

Every year, thousands of international trade shows, business conventions and fairs are held, and millions of commodities are exhibited, such as low-cost plastics, woodenwares, pictures, tablewares, disposable tablewares, ornamental articles, garment accessories, candles, bamboowares, simple furniture, simple office supplies, bags, wallets, simple textile fabrics, toys, light fittings, carpets, light instruments, simple housewares, watches, weighing scales, basic food and basic metalwares, etc.

In many situations, for such low-cost products, the cost to prepare and print a specification form or other presentation material is regarded as unreasonable. Even if it is proved that the product information form is very economical, there may be no time or little time to make the product information form, because such products are often manufactured very soon before the fair.

The language for the product information form is also an essential problem, especially for Chinese vendors. The consistency of the product information form with the general international standards is also an obstacle. The product information form made is often out of line with the minimum standard.

Additionally, on a fair, it is an annoying burden for a visitor to collect, carry and draw off product information forms. It is laborious to look up in a pile of product information forms, which is difficult to operate and preserve. Moreover, classifying and comparisons of the product information forms which is a major purpose for a visitor, can not be very effective when done manually with a large quantity of printed forms. At present, these operations are very difficult.

Presently, the efficiency of post-fair communication with the vendor may be lowered due to time difference, culture and language. However, it is obvious that negotiation with the vendor is necessary, in order to customize and improve the original product or to meet the demands of the buyer. For sales promotion, the vendor needs the information from the visitor or potential buyer who is interested in his product.

Nowadays, mobile phone barcode technology has been put forward, for example, in CN Application No. 200410009771.3. In this technical solution, a barcode is attached to the advertisement, a mobile phone may collect the barcode and send it to an advertisement server, and the advertisement server feeds the detailed information of the advertisement corresponding to the barcode back to the mobile phone. The disadvantages of this technical solution lies in that the advertisement information is directly fed back to the mobile phone of the visitor, but the screen of the mobile phone is too small to read the details of the advertised product. Further more, the cost is very high to send data such as video, audio and picture information to the mobile phone of the visitor, and it is not convenient to collect the information of a plurality of products of the same category for comparison and analysis. Because the information of the advertised product is stored in the mobile phone, and the memory of the mobile phone is usually relatively small, the data volume that can be stored is very restricted. Further more, it is not convenient to print the data in the mobile phone due to the limitation on the data format. Furthermore, the identifying method based on taking a photograph of the barcode using a mobile phone's built-in camera is not reliable for intensive operation. Furthermore, the information flow this way may is not immediate and may not be easy to operate and may require specific skills which are not available to all possible visitors. As a result, this technical solution cannot be used to the fair with a large number of products presented.

### SUMMARY OF THE INVENTION

An embodiment of the invention provides a system for exchanging information, comprising a registering device adapted for entering a visitor ID; a label reader having a label reader ID comprising a reading unit for reading label information from a label associated with a product so as to acquire product information form related to the product; wherein the label reader ID corresponds to the visitor ID. Hereinafter, the term ‘label information’ refers to information contained or stored in the label, for example, label ID, compacted product information form, etc.

An embodiment of the invention provides a label reader having a label reader ID which includes a reading unit for reading label information from a label associated with a product, the label reader ID corresponding to a visitor ID.

In comparison with the prior art, the invention has following advantages.

By associating the visitor ID with the receiving address and associating the label information with the product information form, the product information form in which the visitor is interested is sent to the designated receiving address directly, thus it may be avoided that the visitor has to carry the product information form, and the visitor may report to the company in time.

The legibility may be improved for the buyer and the visitor, because the receiving address may correspond to printer, an electronic mailbox, a facsimile, an Internet user or the address of storage equipment, or any other electronic device for receiving of information rather than being limited to hand-held equipment.

The vendor and the buyer may further understand the market feedback of a product, because the visitor comment data may be sent to the operation server in voice, graphics or text.

The product information forms associated with the same receiving address designated by the same visitor ID are sent collectively, or the product information forms associated with the same receiving address are sent collectively, or each product information form is sent individually, so that it's convenient for the receiver to sort and analyze the data.

The operation server may generate an association table of the visitor and the product information form or an association table of the receiving address and the product information form, according to the association between the receiving address and the visitor ID and the association between the product information form and the barcode information in the existing barcode based system mentioned above. Thus, the vendor may know that which visitor or receiving address of the buyer is interested in which product; and the buyer may know that in which product he is interested.

### BRIEF DESCRIPTION OF THE DRAWINGS

FIG. 1 is a diagram showing the system for exchanging information according to an embodiment of the invention;

FIG. 2 is a flow chart showing the generation of an RFID according to an embodiment of the invention;

FIG. 3 is a flow chart of the method for exchanging information according to an embodiment of the invention;

FIG. 4 is a schematic diagram showing the method for reading an RFID label according to an embodiment of the invention;

FIG. 5a-FIG. 5d are schematic diagrams showing the methods for exchanging information according to an embodiment of the invention;

FIG. 6 is a schematic diagram showing a product information form according to an embodiment of the invention;

FIG. 7 is a schematic diagram showing the interface of a product information form template according to an embodiment of the invention;

FIG. δa and FIG. δb are schematic diagrams showing the data relation according to an embodiment of the invention; and

FIG. 9 is a diagram showing the association of the visitor comment data.

### DETAILED DESCRIPTION OF THE EMBODIMENTS

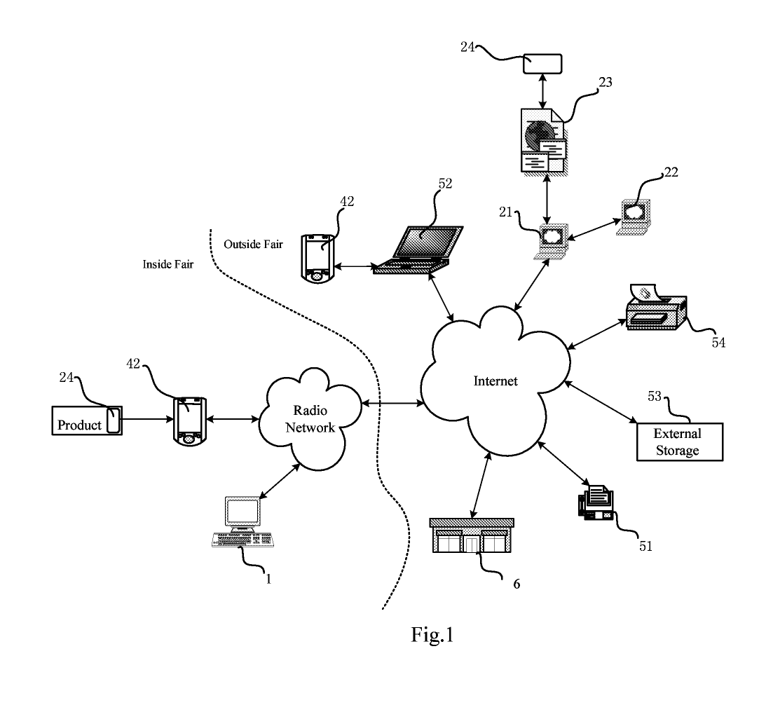

Referring to FIG. 1, a system for exchanging information according to an embodiment of the invention may be divided into inside-fair equipment terminal and outside-fair equipment terminal, wherein the inside-fair equipment mainly comprises a label reader, for example an RFID (Radio Frequency Identification) reader, and a registering device 1. The outside-fair equipment mainly comprises an operation server 21, a receiving device corresponding to a receiving address which may correspond to, for example, an email address, or a fax number, and a terminal for a vendor 6 to enter the information in a product information form 23. Of course, registration may also be performed outside the fair. For example, the registering device may be connected to the operation server, and a visitor may register via the Internet or other available networks. The above equipment is interconnected and communicates with each other via a radio network (for example, a mobile network or a wireless local area network) or Internet. Of course, when necessary, some devices may communicate with each other via wired connection. In the embodiment as shown in FIG. 1, the operation server 21 communicates with other devices in the system via internet Alternatively, the operation server 21 may communicates with other devices in the system via a local area network.

In particular, the system for exchanging information according to the embodiment of the invention as shown in FIG. 1 includes:

a registering device 1, for entering a visitor ID and a receiving address of a product information form 23 designated by the visitor, and sending the visitor ID and the receiving address to the operation server 21 for associating and storing. In this embodiment, this registering device is for visitor registration only and is nor related to the product information form. Those skilled in the art may understand that a plurality of registering devices at different locations may be used.

a label reader, for example, an RFID reader 42, including a reading unit for collecting information included in an RFID label associated with a product and a sending unit for sending the RFID information and information associated with the label reader, e.g., which may include the label reader ID and/or the visitor ID, to the operation server 21 over a radio network;

an operation server 21, for storing and updating the product information form 23 and sending the product information form 23 that matches the label ID, here is an RFID information to the label reader and to any receiving address designated by the visitor, here each product information form 23 corresponds to a unique RFID information. The operation server may use the stored information for further services such as statistical information for visitors or vendors, such as product manufacturers or providers.

The RFID and possible other product related information contained in an RFID label 24 associated with a product may contain a code identifying the product code and/or a code identifying the vendor ID and/or the RFID, and/or product information form and/or related product information form ID.

The system for exchanging information according to an embodiment of the invention may further include a redundant server 22, for backing up the data in the operation server 21.

The receiving address corresponds to, for example, a label reader with receiving capabilities, the number of a handset, a printer address, an electronic mailbox, an Internet user who has registered in the present system, a facsimile or the address of storage equipment, which may be outside the fair. The receiving device corresponding to the respective receiving address is, for example, a label reader, a mobile phone 55 (not shown), a printer 54, a computer terminal 52, a facsimile apparatus 51 or an external storage 53 (such as removable hard disk, FLASH memory, USB disk and so on). Of course, the receiving device is not limited to be outside the fair. Instead, it may also be inside the fair. For example, the concerned product information form 23 may be copied from the registering device 1 into a removable hard disk by accessing the operation server 21 via network, or after the fair, the visitor may access the operation server 21 with his/her registration information (associated with the visitor ID), and the operation server 21 lists the product information form 23 in which the visitor is interested in, according to the RFID information sent by the visitor's label reader, or the product information form 23 designated by the visitor is sent to the printer 54 for printing, or the product information form 23 is sent to the facsimile apparatus 51 to be faxed.

The operation server 21 may send the product information forms 23, associated with a receiving address designated by the visitor corresponding to a visitor ID, to the receiving address collectively, or may send the product information forms 23 to a same receiving address designated the visitor, or may send each product information form 23 separately. For example, the visitor may designate a receiving address for each type of product when registering. Thus, the visitor does not need to classify the product information forms and report them to different persons. If one company dispatches several persons to a fair and the same receiving address is used, all the product information forms associated with the receiving address may be sent together to the receiving address.

In an embodiment, the label reader may be equipped with a receiving unit and/or a display unit, such as a LCD display, and/or navigation buttons, such as Up, Down, Right, Left, and/or OK buttons, or the like. The operation server may optionally send information, such as the product information forms, advertisement information, messages, etc., to the label reader. Upon receipt of the information sent from the operation server by the receiving unit of the label reader, the display unit of the label reader may show the graphical and/or text and/or animation information and/or sounds if available, as well as the manufacturer information. Then the visitor may browse and edit the received information immediately with the label reader, and decide to save or delete the information received. The receiving unit of the label reader may receive the information sent from the operation server in a wireless manner or in a wired manner. In an embodiment, the label reader may be equipped with a microphone for inputting the visitor's voice, such as remark messages about a product. In an embodiment, the label reader may be equipped with a speaker so that the label reader may confirm the reading of a label with a sound notification, or present a message sent from the operation server with the speaker. The visitor may also listen to voice remark messages recorded in the label reader using the speaker. In an embodiment, the label reader may be equipped with a headphone jack. The label reader may be made compact and portable, for example, may be in the form of a card. In an embodiment, the label reader may have a built-in interface, such as a USB port, to be connected with a PC so as to exchange information with the PC. In an embodiment, the reader may be equipped with a means of communications for data exchange with another reader, for exchanging information such as mutual visitor details.

In another embodiment, the label reader may be a barcode reader. The label reader may collect label information, in this case, barcode information included in a barcode label associated with a product and sending the barcode information and information associated with the label reader, e.g., which may include the label reader ID or the visitor ID, to the operation server. The processing of the barcode information in the operation server is similar to that of the RFID. Of course, the barcode reader may be configured to have the above mentioned additional functions of communications and reading/writing and other features other then reading. The barcode may be a one-dimension barcode or a two-dimension barcode.

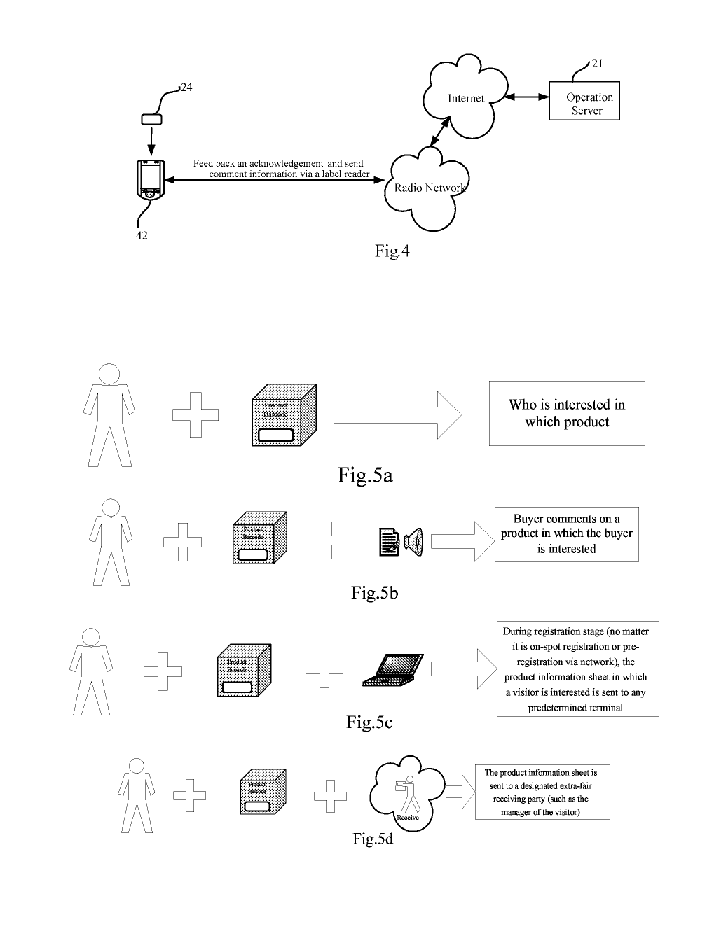

Referring to FIG. 4, the label reader is a wireless RFID reader 42, the visitor ID is programmed in the visitor's label reader. The wireless RFID reader 42 includes: an RFID reader unit, for reading the RFID label 24 attached to a product; a radio network interface, for sending the RFID information read from the RFID label 24 and the label reader ID wirelessly; and a display unit, for receiving and displaying acknowledgement and the product information. In another embodiment, the wireless label reader 41 includes: an RFID reading unit, for reading the RFID information from the RFID label 24 attached to a product; a decoding unit, for decoding the RFID information 24 to obtain the product information form ID; a radio network interface, for sending the product information form ID and the label reader ID wirelessly and to receive information from the server such as acknowledgements and other data. The RF communications may be bi-directional or unidirectional; and may further include a display unit, for receiving and displaying acknowledgement and product information. The radio network interface accesses the Internet or other network via a radio network infrastructure, for transferring data to the operation server 21. The acknowledgement information refers to a feedback returned by the operation server 21 when the operation server 21 receives a request for the corresponding product information form, which indicates that the request is received, such as “the request for the product information form of ** is received”, followed by reception of the product information form directly to the label reader. Alternatively, the acknowledgement information may be presented to the visitor in other manners. For example, the acknowledgement information may be presented via a speaker in the label reader, or via a short message or an email sent to a mobile terminal of the visitor.

In an embodiment, the label reader, for example, RFID reader may comprise the function for making communications between the reader and the label in bidirectional way, that is, the label reader further includes a writing unit, in addition to the reading unit, according to the technology used. With the writing unit the label reader is capable of writing data into the label. Written information may include visitor details for immediate update of statistical information per the referred product, for example, in case of using RFID read/write, exchanging data between the reader and the label involves writing the visitor ID to the label. In addition, the read information may include partial or full product information, not only ID, according to the label type, capacity and technology used.

A person of ordinary skill in the art may understand that, as an alternative, any kind of appropriate label for identifying a product and corresponding label reader for reading label information, for example, a barcode label and a barcode reader, may be used in addition to the RFID label and the RFID reader described in the embodiments above. The label for identifying a product may be attached to the product, or may be put aside the product, or may be associated with the product in other appropriate manners.

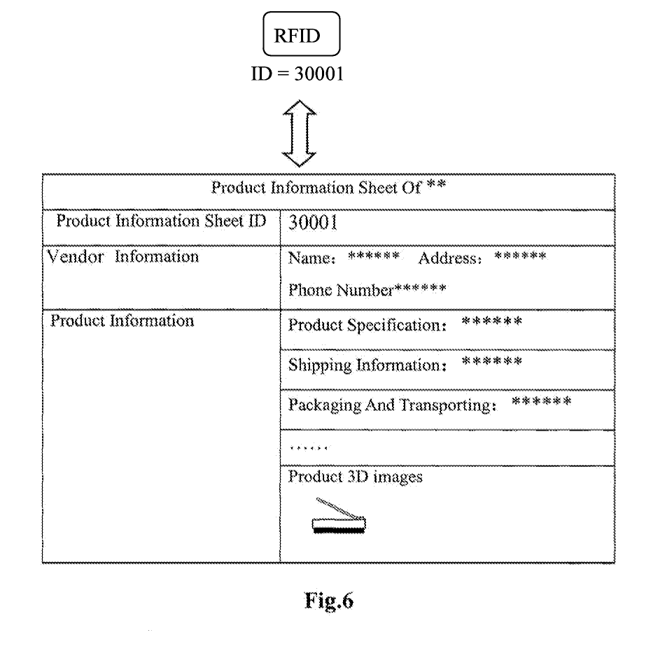

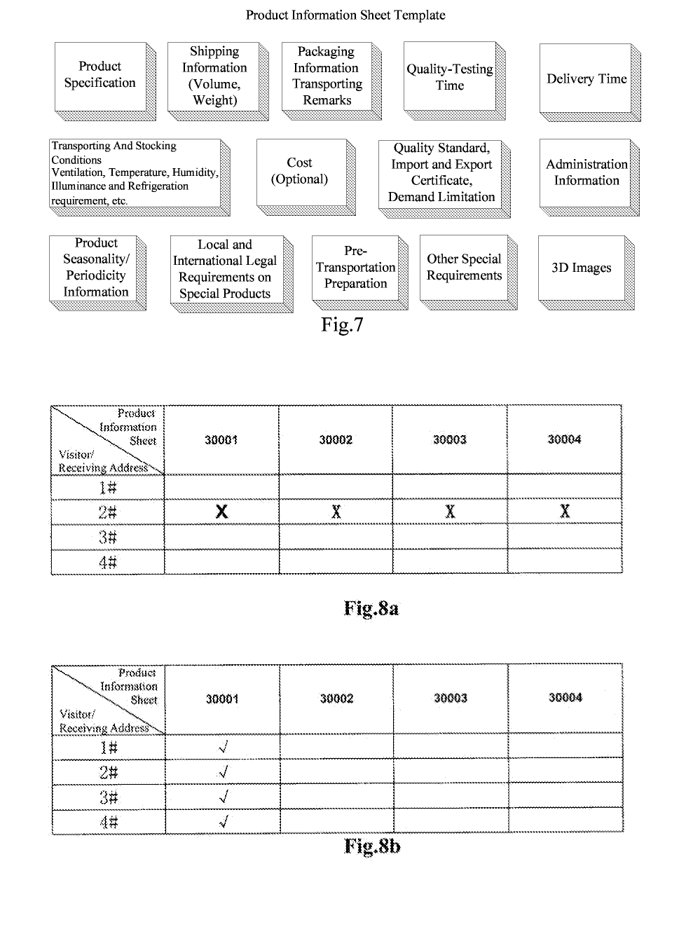

Referring to FIG. 6 and FIG. 7, the data in a product information form 23 includes: the product information form ID generated by the operation server 21. Each product corresponds to a product information form 23, and each product information form has a unique product information form ID (such as 30001, which is the same as the RFID code). Correspondingly, each product information form generates a RFID pattern 24.

Referring to FIG. 7 again, a vendor 6 may access the operation server 21 and click each item of the product information form template, for issuing product information, which includes, but not limited to: shipping information (volume, weight), packaging and transporting remarks, quality-testing time, delivery time, information of transporting and stocking conditions, quality standard information, information of import and export certificate, administration information, product seasonality information, information of local and international legal requirements, information of pre-transportation preparation, some other special requirements, cost, and 3D images for disassembling and assembling the product structure, etc., wherein the 3D images are adapted to see the internal structure of a product clearly. Vendor 6 may update his product information via the product information form template. The product information template may be translated into the languages of various countries, in order to meet the requirements of the visitor. In other words, it has editions of various languages, such as English edition, Chinese edition, Japanese edition and so on.

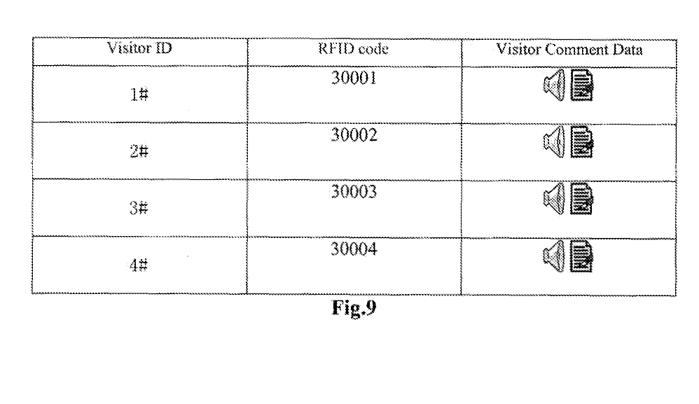

Referring to FIG. 9, the operation server 21 is further adapted to store and update visitor comment data, which are the text data or/and voice data of the comments on a product sent by a visitor, wherein the visitor comment data is associated with the visitor ID and the RFID code. For example, visitor IDs 1#, 2#, 3# and 4# are respectively associated with RFID codes 30001, 30002, 30003 and 30004 and the product comment data thereof. The visitor may input the comment information via his label reader which may optionally be equipped with voice recording capability. For example, after a visitor sees a product, the visitor may send text information via a his label reader for commenting on the product, or send messages to the operation server 21 or send voice information for commenting on the product. For association, the RFID information and the visitor ID are sent at the same time when the visitor comment data is sent. Or, the visitor may send messages to the operation server 21 for releasing comments on the product, wherein the visitor may input the RFID code (i.e., product information form ID as received following reading the RFID label attached to the product) and the visitor ID according to the voice prompt of the operation server 21, and then leave a word for commenting. For the collection of visitor comment data, reference may be made to the collection method of product information forms, and the visitor may use his label reader for listening to the voice comments or editing the text comments and sending them to the designated receiving address. Thus, the visitor or the receiver may hear or see the preliminary impressions and comments on each product in which he is interested. Alternatively, the visitor may read the RFID or barcode label via a mobile phone or Personal Digital Assistant (PDA) with a built-in camera, or via a camera, instead of his label reader. In the case of barcode or similar codes, the visitor may input the barcode number with the keyboard of a mobile phone or PDA or other terminal manually.

To implement communication between the above inside-fair label reader and the operation server 21, for example, the radio network carrier allocates a number 8888 to the operation server 21, and the label reader sends data or voice recording to this number “8888” or directly dials the number “8888” via a mobile phone to leave a word.

Referring to FIG. 3, the method for exchanging information according to an embodiment of the invention includes the following steps.

Step 301: A visitor ID and a receiving address for a product information form designated by the visitor are entered.

Step 302: The visitor ID and the receiving address are sent to an operation server for associating and storing.

Step 303: RFID information label attached to a product is collected, and the RFID information together with the visitor ID is sent to the operation server.

Step 304: The operation server sends a product information form that matches the RFID information to the receiving address designated by the visitor, wherein each product information form corresponds to unique RFID information.

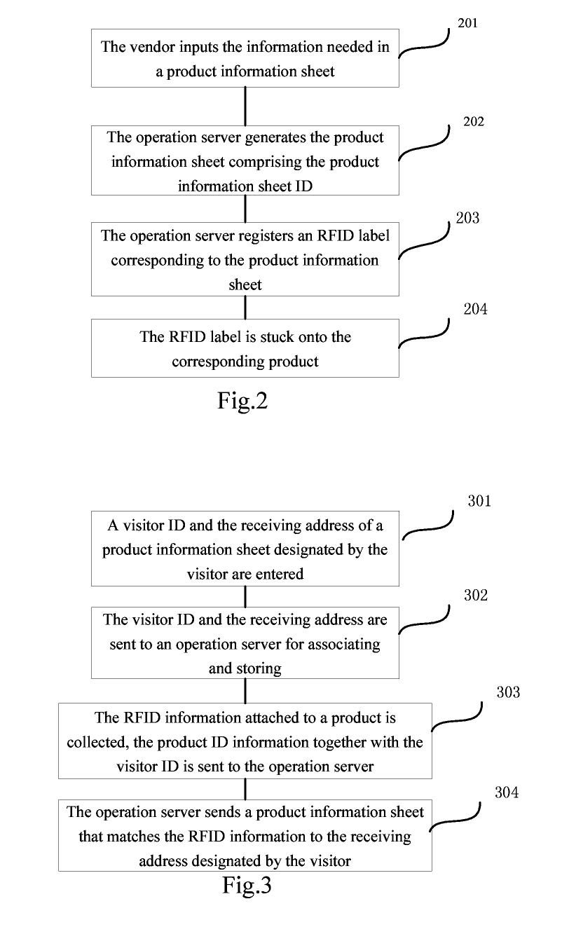

Referring to FIG. 2, the method further includes the following steps before Step 301.

Step 201: The vendor inputs the information needed in the product information form.

Step 202: The operation server generates a product information form comprising the product information form ID.

Step 203: The operation server registers an RFID label with a code corresponding to the product information form, wherein an RFID label is sent to the vendor for attaching to the product.

Step 204: The RFID label is attached to the corresponding product, and the product attached with the label is exhibited or presented.

The method for exchanging information further includes the following steps. The visitor sends text data or/and voice data of the comments on a product to the operation server, and the operation server associates the comment data with the visitor ID and the RFID code, and stores the data. The visitor logs on the operation server using their label reader for receiving and listening to the voice comments or editing the text comments and sending them to the designated receiving address. It would be appreciated that the above methods are also applicable to the situation when a barcode or other appropriate label is used.

Referring to FIG. 5a, FIG. 8a and FIG. 8b, the operation server generates an association table of the visitor and the product information form or an association table of the receiving address and the product information form, according to the association between the receiving address and the visitor ID and the association between the product information form and the RFID information. As shown in FIG. 5a and FIG. 8a, the visitor ID is associated with the RFID information, so that it may be obtained that in which product a certain visitor or a certain receiving address is interested. For example, visitor or receiving address 2# is interested in products A, B, C and D. Or, it may be obtained that which visitor or receiving address is interested in a certain product. As shown in FIG. 8b for example, visitors or receiving addresses 1#, 2#, 3# and 4# are interested in product A. As a result, the vendor may know the market prospect of his product.

As shown in FIG. 5b, a buyer (visitor) comments on a product via voice or text data, and raises the requirements and feedbacks, so that the vendor may improve his product, and the visitor's on-spot impression may be reflected.

As shown in FIG. 5c, during registration stage (no matter it is on-spot registration or pre-registration via network), the terminal-type receiving address is input, and the product information form in which a visitor is interested is sent to the designated receiving terminal.

As shown in FIG. 5d, it is similar to FIG. 5c, except that the product information form is sent to the designated receiving party. For example, the manager of the visitor receives the product information form via an Email or a mobile phone, so that the information may be reported to the supervisor instantly, and the incompletion and inaccuracy of information when a visitor could at the most call the supervisor to report on a fair may be avoided.

In the invention, by associating the visitor ID with the receiving address and associating the RFID code with the product information form, the product information form in which the visitor is interested is sent to the designated receiving address directly, thus it may be avoided that the visitor has to carry the product information form, and the visitor may report to the company in time.

The legibility may be improved for the buyer and the visitor, because the receiving address may be a printer, an electronic mailbox, a facsimile, an Internet user or the address of storage equipment, rather than being limited to hand-held type equipment.

The vendor and the buyer may further understand the market feedback of a product, because the visitor comment data may be sent to the operation server in voice or text.

The product information forms associated with the same receiving address designated by the same visitor ID are sent collectively, or the product information forms associated with the same receiving address are sent collectively, or each product information form is sent individually, so that it's convenient for the receiver to sort and analyze the data.

The operation server may generate an association table of the visitor and the product information form or an association table of the receiving address and the product information form, according to the association between the receiving address and the visitor ID and the association between the product information form and the RFID information. Thus, the vendor may know that which visitor or receiving address of the buyer is interested in which product, and the buyer may know that in which product he is interested.

According to some embodiments of the invention there is provided a system for exchanging information, which comprises: a registering device, for entering a visitor ID and a receiving address of a product information form designated by a visitor, and sending the visitor ID and the receiving address to an operation server for associating and storing; a barcode reader, for collecting the barcode information attached to a product, and sending the barcode information and the visitor ID to the operation server; an operation server, for storing and updating the product information form, and sending the product information form that matches the barcode information to the receiving address designated by the visitor, wherein each product information form corresponds to unique barcode information.

Further, the barcode information may comprise a barcode pattern, a barcode code or a combination thereof, wherein the barcode code may be a product information form ID.

Further, the barcode reader may be a wireless barcode reader, and the visitor ID may be the equipment ID of the barcode reader, which comprises: a scanning unit, for reading the barcode pattern attached to the product; a Blue Tooth unit, for sending the barcode pattern and the equipment ID wirelessly; and a display unit, for receiving and displaying acknowledgement information.

Further, the barcode reader may be a wireless barcode reader, and the visitor ID may be the equipment ID of the barcode, for reading the barcode pattern attached to the product; a decoding unit, for decoding the barcode pattern to obtain the product information form ID; a Blue Tooth unit, for sending the product information form ID and the equipment ID wirelessly; and a display unit, for receiving and displaying acknowledgement information.

Further, the visitor ID may be the number of hand-held equipment, while the barcode reader may be bidirectional communication hand-held equipment, for inputting the barcode code, sending the barcode code and the number of the hand-held equipment, and receiving and displaying acknowledgement information.

Further, the visitor ID may be a handset number, while the barcode reader may be a mobile phone with a camera module and a decoding unit built in, for shooting the barcode pattern and decoding the barcode pattern to obtain the product information form ID, sending the product information form ID and the handset number, and receiving and displaying acknowledgement information.

Further, the visitor ID may be a handset number, while the barcode reader may be a mobile phone with a camera module built in, for shooting the barcode pattern, sending the barcode pattern and the handset number, and receiving and displaying acknowledgement information.

Further, the visitor ID may be the equipment ID of a barcode reader, the barcode reader may be a combination of a mobile phone and the barcode reader, wherein the barcode reader may be adapted to read the barcode pattern attached to the product and send the barcode information and the equipment ID wirelessly, and the mobile phone may be adapted to associate with the visitor ID according to the handset number, receive and display acknowledgement information, and send visitor comment data.

Further, the receiving address may be a handset number, a printer address, an electronic mailbox, a facsimile, an Internet user who has registered in the present system or the address of external storage equipment, which may be outside the fair.

Further, the operation server collectively sends the product information forms associated with the same receiving address designated by the same visitor ID, or collectively sends the product information forms associated with the same receiving address, or individually sends each product information form.

Further, the operation server further stores and updates the visitor comment data, which are the text data or/and voice data of the comments on the product sent by the visitor, wherein the visitor comment data are associated with the visitor ID and the barcode code.

Further, the data in the product information form may comprise the product information form ID generated by the operation server and the following information issued by the vendor: shipping information, packaging and transporting remarks, quality-testing time, delivery time, information of transporting and stocking conditions, quality standard information, information of import and export certificate, administration information, product seasonality information, information of local and international legal requirements, information of pre-transportation preparation, and 3D images for disassembling and assembling the product structure.

Further, the system further comprises a redundant server, for backing up the data in the operation server.

Correspondingly, there may be provided a method for exchanging information according to an embodiment of the invention, which comprises: entering a visitor ID and a receiving address of a product information form designated by a visitor; sending the visitor ID and the receiving address to an operation server for associating and storing; collecting the barcode information attached to a product, and sending the barcode information together with the visitor ID to the operation server; and sending, by the operation server, a product information form that matches the barcode information to the receiving address designated by the visitor, wherein each product information form corresponds to unique barcode information.

Further, the method for exchanging information further comprises a decoding step before sending the barcode information to the operation server or after receiving the barcode information via the operation server, in which a barcode code may be obtained from the barcode pattern, and the barcode code may be a product information form ID.

Further, the method for exchanging information further comprises: sending text data or/and voice data of the comments on the product to the operation server by the visitor; associating and storing the visitor comment data with the visitor ID and the barcode code by the operation server; and the visitor logging in the operation server, for listening to the voice comments or editing the text comments and sending the text comments to a designated receiving address.

Further, the operation server sends a barcode information receipt-feedback acknowledgement.

Further, the operation server generates an association table of the visitor and the product information form or an association table of the receiving address and the product information form, according to the association between the receiving address and the visitor ID and the association between the product information form and the barcode information.

Further, the method for exchanging information further comprises: inputting the information needed in the product information form by a vendor; generating a product information form comprising the product information form ID by the operation server; generating a barcode corresponding to the product information form by the operation server; and sticking the barcode onto the corresponding product.

In comparison with the prior art, the invention has following advantages.

By associating the visitor ID with the receiving address and associating the barcode with the product information form, the product information form in which the visitor is interested is sent to the designated receiving address directly, thus it may be avoided that the visitor has to carry the product information form, and the visitor may report to the company in time.

The legibility may be improved for the buyer and the visitor, because the receiving address may corresponds to a printer, an electronic mailbox, a facsimile, an Internet user or the address of storage equipment, rather than being limited to hand-held equipment.

The vendor and the buyer may further understand the market feedback of a product, because the visitor comment data may be sent to the operation server in voice or text.

The product information forms associated with the same receiving address designated by the same visitor ID are sent collectively, or the product information forms associated with the same receiving address are sent collectively, or each product information form is sent individually, so that it's convenient for the receiver to sort and analyze the data.

The operation server may generate an association table of the visitor and the product information form or an association table of the receiving address and the product information form, according to the association between the receiving address and the visitor ID and the association between the product information form and the information. Thus, the vendor may know that which visitor or receiving address of the buyer is interested in which product; and the buyer may know that in which product he is interested.

In another embodiment, the system for exchanging information is based on contactless Smartcard technology, including ISO 14443 and ISO 15693, etc. The operation frequency defined in ISO 14443 and ISO 15693 is 13.56 MHz, providing a read range up to 10 cm, while the operation frequency defined in the proximity technology is, for example, 125 KHz. In the system, in addition to the reading unit for reading label information from a label associated with a product, the label reader may further include a writing unit for writing information into the label wirelessly, allowing interactive action with the label. In this case, the label has a memory for storing information from the label reader. For example, the information written into the label by the label reader may include different selections such as request for different product color etc. and add textual requests, as well as the information associated with the label reader such as the label reader ID, the information associated with the user of the label reader (i.e., a buyer or a manufacturer).

In an embodiment, the label reader may include a storing unit for storing the information, such as product ID and/or vendor ID and/or product information form and/or product information ID, read from a label associated with a product. In this case, the label reader may choose to send the label information to the operational server, so as to obtain more information on the product and manufacturer from the operation server. Alternatively, the label reader may choose not to send the label information to the operational server.

In an embodiment, the label reader may include a display. In the case of a graphic display, the label reader may display the information on the display showing images and graphical information. In the case of a multi-line textual display, the label reader displays only textual information.

In an embodiment, the label reader may include a microprocessor which handles the communication and data storage, and performs functions such as mathematical calculations.

In an embodiment, the information stored in the label reader may be secured by special, application-specific security keys which lock the storing unit for external read/write access.

Hereinafter, a smartcard technology based process for exchanging information in a fair will be described. This process assumes that the devices, e.g., labels, label readers, are equipped with the required capacity designed for the required performance in which the information is manipulated by the label readers, i.e., buyer's reader and manufacturer's reader, stored in the labels and delivered by the labels from the manufacturer to the buyer or vice versa. The manufacturer's reader is basically identical to the buyer's reader but contains different applications.

When a buyer is interested in a product at a manufacturer's booth. The buyer brings his label reader in reading proximity with the product's label and starts reading information from the label. The buyer's label reader reads, for example, the product ID and the manufacturer's ID, from the label and stores them in its storing unit, for example, a memory. In an embodiment, the buyer's label reader reads and stores in addition a compacted, summarized product information form stored in the label. The compacted product information form is a summarized from the production information form described above. In an embodiment, the compacted product information form may allow interactive action. In that case, the buyer may perform different selections such as request for different product color etc. and add textual requests. When done, the buyer may transmit the requirements information to the label in a similar manner of the reading process. The label stores them for further processing by the manufacturer. In any case the requests information may be stored in the storing unit of the label reader for later downloading. The memory on the label is for immediate information for the manufacturer and can not be backed-up until the manufacturer's label reader reads the label information.

In an embodiment, in the case of a buyer's label reader equipped with a sending/receiving unit (for example, using proprietary RF, WLAN or other technology), the buyer's label reader may transmit the information, for example, through a local RF network, to the operational server. The server stores the information for further handling, and responds with acknowledgement message to the buyer's label reader. In an embodiment, the server may inform the buyer's label reader with other types of related information such as similar requests, product updates and availability.

The buyer's label reader may store all the information collected and generated, including: manufacturer's ID, product ID, date and time stamp, compacted product information form, requests and product information selections. The information will be uploaded later, for example, when the buyer connects the label reader to a PC. In an embodiment, the information may be uploaded to the operational server for further processing, so that the operational server may send the information to a receiving address registered by the buyer.

After the buyer's reading/writing process is complete, the information is stored at the label's memory. In the case of a manufacturer's label reader equipped with RF communications, the system may alert the manufacturer's label reader that there is a new interest in a product. The label reader will display the information regarding which product, the interested buyer contact details and if there are special requests or not.

Alternatively, the manufacturer may get the information directly from the product's label.

The manufacturer, either per notification or not, may periodically use the label reader to read the product labels to get informed regarding buyer's interests. The manufacturer's label reader reads a product label, and synchronizes its relevant data per history of buyer readings and inputs. The label reader will alert the manufacturer if a certain product gained buyers' interest and inputs. In that case, the label reader will display the buyer's contact details and their requests information.

In the case of a manufacturer's label reader with RF bidirectional communications, the manufacturer may use the label reader to send a message to an interested buyer, e.g., to the label reader of the buyer, and to invite him for a meeting.

The manufacturer's label reader, once read the updated labels' information, may provide statistical information regarding interest in their products to the manufacturer at any time. In the case of an urgent request which requires decisions in a higher management level, the manufacturer may connect his label reader to a PC that is tied to a network, for example, a LAN/WAN, and transmit the information to the office, for example, through the operational server.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this disclosure, shall refer to this application as a whole and not to any particular portions of this disclosure. When the claims use the word “or” in reference to a list of two or more items, that word covers all of the following interpretations of the word: any of the items in the list, all of the items in the list and any combination of the items in the list.

While some preferred embodiments of the present invention have been described above, the scope of the present invention shall not be limited thereto. Those skilled in the art may make various changes and modifications without departing the scope of the present invention. It is thus intended that all these changes and modifications shall fall within the scope of the present invention as defined in the appended claims.

For example, in the embodiments described above, a label for identifying a product is a barcode or RFID label, and the corresponding reader is a barcode reader or an RFID reader. However, those skilled in the art may understand that, as an alternative, any kind of appropriate label for identifying a product and corresponding label reader for reading label information may be used in addition to the label and the label reader described in the embodiments above. Further, in the label reader, the wireless data transmitting is not limited to the technology of Blue Tooth, any appropriate wireless technology may be used for wirelessly transmitting data read from a label, for example, RF, WLAN, RFID, IR, WiFi. Further, in the embodiments above, the label reader may transmit data wirelessly, however, the data can also be transmitted in a wired manner.

1. A system for matching a vendor and a buyer at a fair, comprising: an operation server, for storing, processing and handling matching data; a registering device adapted for entering registered visitor data; a label reader having a label reader ID; wherein said label reader includes a reading unit for reading label information from a label associated with a product, and wherein said label reader ID corresponds to said registered visitor data.

2. The system according to claim 1, wherein said label reader further comprises a sending unit for wirelessly sending label information and information associated with the label reader ID to said operation server.

3. The system according to claim 1, wherein said registering device is further adapted to receive a receiving address associated with said visitor data, said receiving address including at least one address selected from the group consisting of an email address, a label reader, a mobile phone, a printer address, a computer terminal, a facsimile apparatus, an Internet user who has registered in the system, and an external storage device or facility.

4. The system according to claim 1, wherein said label reader further comprises a display unit for displaying one or more of acknowledgement data, manufacturer's ID, product ID, date and time stamp, compacted product information form, requests, and product information.

5. The system according to claim 1, wherein said label includes wirelessly transmittable label information, said wireless transmission using a protocol from one or more of RFID, WLAN, IR, Blue Tooth and WiFi.

6. The system according to claim 1, wherein said label reader reading unit is adapted to read label information selected from the set including barcode information, graphic information, text information, RFID data, Blue Tooth data, WLAN, IR, WiFi or other wirelessly transmitted product related data.

7. A method for matching a vendor and a buyer at a fair, comprising: inputting product data into an operation server, by a vendor; generating a product ID; generating a product label with a code corresponding to said product ID; coupling said product label to the product; providing a label reading device, said reading device being associated with a registered visitor ID; and matching said product with said visitor ID of an interested buyer.

8. The method of claim 7, comprising displaying on said label reading device one or more of acknowledgement data, manufacturer's ID, product ID, date and time stamp, compacted product information form, requests, and product information.

9. The method of claim 7, comprising connecting said vendor of said product with an interested buyer of said product, by said operation server.

10. The method of claim 7, comprising associating at least one receiving address with said registered visitor ID, said receiving address selected from one or more of the group consisting of an email address, a label reader, a mobile phone, a printer address, a computer terminal, a facsimile apparatus, an Internet user who has registered in the system, and an external storage device or facility.

11. A system for obtaining product information at an event, including: a registration device having an interface configured to receive a receiving address for product information, the receiving address being designated by a user; a label reader having a unique ID associated with the user, a reading unit configured to read label information from a label associated with a product, and a communication unit configured to transmit the unique ID and label information to a first network coupled to a second network; a server coupled to the second network, the server being configured to receive the receiving address from the registration device, receive the unique ID and label information from the first network, access a database to identify a product information form associated with the label information and the receiving address associated with the unique ID, and forward the product information form to the receiving address.

12. The system of claim 11, wherein the server is configured to compile a group of product information forms associated with one of the unique ID and the receiving address based on a characteristic of the product information forms, thereby permitting the user to compare a characteristic of products associated with the product information forms.

13. The system of claim 11, wherein the registration device interface is configured to permit the user to designate a first receiving address for a first group of products and a second receiving address for a second group of products.

14. The system of claim 11, wherein the label reader includes a storage device configured to store label information associated with a plurality of labels, and a built-in interface for connection to a computing device configured to receive the label information and transmit the label information to the server via the second network.

15. The system of claim 11, wherein the label reader includes a user interface configured to permit the user to input user information relating to the product.

16. The system of claim 11, wherein the label reader further includes a writing unit configured to write information to the label.

17. The system of claim 16, wherein the label includes a memory for storing information written by the writing unit.

18. A method for managing information relating to products displayed to visitors during an event at a location, including the steps of: prompting the visitor to input at least one receiving address for receiving product information associated with the visitor; associating a label reader with the visitor, the label reader having a unique ID and a reading unit configured to read label information from labels associated with the products; providing a local network at said location configured to receive the unique ID and label information associated with the products of interest to the user from the label reader, and transmit the unique ID and label information to a remote network outside said location; and operating a server coupled to the remote network and configured to receive the unique ID and label information from the local network and, the server sending at least one product information form associated with the label information to the receiving address.

19. The method of claim 18, further including the step of matching a vendor to a visitor, based on at least a product of interest selected by the visitor.

20. The method of claim 18, further including the step of enabling the visitor to communicate label information to a computing device coupled to the remote network.
